(19) United States
(12) Patent Application Publication
(10) Pub. No.: US 2022/0288694 A1
(43) Pub. Date: Sep. 15, 2022

(54) VARIABLE MATERIAL DEPOSITION AREA FOR MATERIAL SUPPLY DEVICE WITHIN ADDITIVE MANUFACTURING SYSTEM

(71) Applicant: NIKON CORPORATION, Tokyo (JP)

(72) Inventors: Michael Birk Binnard, Belmont, CA (US); Motofusa Ishikawa, Saitama-ken (JP)

(21) Appl. No.: 17/686,679

(22) Filed: Mar. 4, 2022

Related U.S. Application Data
(60) Provisional application No. 63/161,304, filed on Mar. 15, 2021.

(51) Int. Cl. B22F 12/50; B22F 10/28; B22F 12/30; B29C 64/153; B29C 64/245; B33Y 10/00; B33Y 30/00

(52) U.S. Cl. CPC B22F 12/50; B22F 10/28; B22F 12/30; B29C 64/153; B29C 64/245; B33Y 10/00; B33Y 30/00

(57) ABSTRACT

A processing machine (10) for building a three-dimensional object (11) from material (12) includes a build bed (28); a material supply device (18); and a build area cover assembly (30). The build bed (28) is configured to support the material (12) to provide a build surface (29) at which the three-dimensional object (11) is to be built. The material supply device (18) is configured to deposit material (12) to the build bed (28). The build area cover assembly (30) is configured to variably define a material deposition area (34) of the build surface (29). The build area cover assembly (30) can be movable relative to the build bed (28) and can control a size and shape of the material deposition area (34) of the build surface (29).

### RELATED APPLICATIONS

This application claims priority on U.S. Provisional Application No. 63/161,304 filed on Mar. 15, 2021, and entitled “VARIABLE MATERIAL DEPOSITION AREA FOR MATERIAL SUPPLY DEVICE WITHIN ADDITIVE MANUFACTURING SYSTEM”. As far as permitted the contents of U.S. Provisional Application No. 63/161,304 are incorporated in their entirety herein by reference.

### BACKGROUND

Three-dimensional printing systems are used to print three-dimensional objects. Existing three-dimensional printing systems are relatively slow, have a low throughput, are expensive to operate, and/or generate excessive waste. As a result thereof, there is a never ending search to increase the speed and the throughput, reduce the cost of operation, and minimize material waste in three-dimensional printing systems.

### SUMMARY

The present implementation is directed toward a processing machine for building a three-dimensional object from material. The processing machine can include a build bed; a material supply device; and a build area cover assembly. The build bed is configured to support the material to provide a build surface at which the three-dimensional object is to be built. The material supply device is configured to deposit material to the bed surface. The build area cover assembly is configured to variably define a material deposition area of the build surface.

In one implementation, the processing machine further includes a work member on which the three-dimensional object is built that is supported by the build bed. In such implementation, the material supply device deposits the material onto the work member.

In one implementation, the build area cover assembly is movable relative to the build bed and controls a size and shape of the material deposition area of the build surface.

In one implementation, the size and shape of the material deposition area is controlled by the build cover assembly covering at least a portion of the build surface.

In one implementation, the build area cover assembly is configured to control a size of an opening onto the build surface to control the size and shape of the material deposition area of the build surface.

Additionally, in one implementation, the size of the material deposition area is variable based at least in part on the movement of the build area cover assembly.

Further, in one implementation, the build cover assembly also controls the amount of the material deposited within the material deposition area.

The processing machine can further include a material bed that movably supports the build bed. In one implementation, the build area cover assembly is coupled to the material bed.

In certain implementations, the build bed is movable relative to the material supply device.

In some implementations, the build area cover assembly includes one or more assembly members that are movable relative to the build bed with at least one member mover to cover the at least a portion of the build surface. Additionally, the one or more assembly members can be formed from a high-temperature material. Further, the one or more assembly members can be formed from at least one of ceramic, molybdenum, niobium, and tungsten.

In one implementation, the material supply device is configured to deposit the material onto the build surface so that the material is spaced apart from the one or more assembly members.

In certain implementations, the one or more assembly members includes a plurality of individually controllable thin plates that are each movable to cover at least a portion of the build surface. In one such implementation, the at least one member mover includes a separate member mover for each of the plurality of individually controllable thin plates.

In other implementations, the one or more assembly members includes a pair of substantially L-shaped assembly members that are each movable to cover at least a portion of the build surface. In some such implementations, each of the pair of substantially L-shaped assembly members is movable relative to the build bed in a first direction and a second direction that is orthogonal to the first direction to cover at least a portion of the build surface.

In still other implementations, the one or more assembly members includes a plurality of assembly members that are each movable generally inwardly toward a center of the build bed and generally outwardly away from the center of the build bed. In one such implementation, the at least one member mover includes a separate member mover for each of the plurality of assembly members.

In yet other implementations, the one or more assembly members includes a plurality of assembly members that can be moved to cooperatively define a material deposition area of varying size. In one such implementation, all of the assembly members are moved by a common member mover.

In one implementation, the processing machine further includes a material mover that is configured to level an upper material layer of the material that is deposited onto the build surface. Additionally, in such implementation, the material mover can be further configured to move any excess material that has been deposited onto the build area cover assembly into a material receptacle that is positioned substantially adjacent to the build bed.

In certain implementations, the build bed further includes a bed side wall that extends substantially vertically adjacent to a perimeter of the build surface. In one such implementation, the build surface is flat, rectangular-shaped, and wherein the bed side wall is rectangular tube-shaped. In another such implementation, the build surface is flat, circular-shaped, and wherein the bed side wall is circular tube-shaped.

In one implementation, the build area cover assembly is adjustable prior to each material layer of material being deposited onto the build surface. In another implementation, the build area cover assembly is adjusted only once prior to a first material layer of material being deposited onto the build surface such that the material deposition area is a maximum of any size needed during the building of the object.

In a method implementation, the invention is directed to a method for building a three-dimensional object from material including: (i) providing a build bed that is configured to support the material to provide a build surface at which the three-dimensional object is to be built; (ii) depositing material to the bed surface with a material supply device; and (iii) variably defining a material deposition area of the build surface with a build area cover assembly.

### BRIEF DESCRIPTION OF THE DRAWINGS

The novel features of this embodiment, as well as the embodiment itself, both as to its structure and its operation, will be best understood from the accompanying drawings, taken in conjunction with the accompanying description, in which similar reference characters refer to similar parts, and in which:

FIG. 1A is a simplified schematic side view illustration of an implementation of a processing machine including one or more build beds and a build area cover assembly having features of the present embodiment that limits an opening to each of the one or more build beds to control an amount of material that is deposited onto each of the one or more build beds;

FIG. 1B is a simplified schematic top view illustration of a portion of the processing machine illustrated in FIG. 1A;

FIG. 2A is a simplified schematic top view illustration of a build bed and an implementation of the build area cover assembly;

FIG. 2B is a simplified schematic side view illustration of the build bed and the build area cover assembly taken on line B-B in FIG. 2A;

FIG. 3 is a simplified schematic top view illustration of the build bed and another implementation of the build area cover assembly; and

FIG. 4 is a simplified schematic top view illustration of a build bed and still another implementation of the build area cover assembly.

### DESCRIPTION

Implementations of the present embodiment are described herein in the context of a processing machine such as an additive manufacturing system, e.g., a three-dimensional printer, having one or more build beds and a build area cover assembly that selectively controls an opening to each of the one or more build beds to control an amount of material that is deposited within a variable material deposition area onto each of the one or more build beds. With such design, the processing machine can provide a more cost-efficient three-dimensional printing process, by limiting the amount of wasted material, without sacrificing on desired throughput.

Those of ordinary skill in the art will realize that the following detailed description of the present embodiment is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same or similar nomenclature and/or reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application-related and business-related constraints, and that these specific goals will vary from one implementation to another and from one developer to another. Moreover, it is appreciated that such a development effort might be complex and time-consuming, but would nevertheless be a routine undertaking of engineering for those of ordinary skill in the art having the benefit of this disclosure.

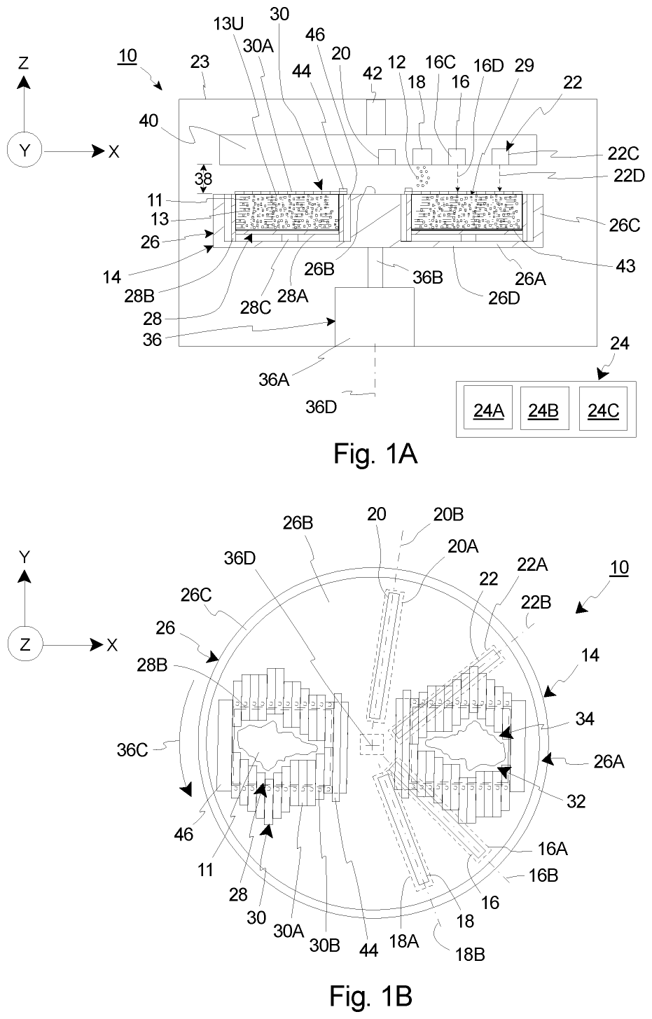

FIG. 1A is a simplified schematic side view illustration of a processing machine 10 that may be used to manufacture one or more three-dimensional objects 11. As provided herein, the processing machine 10 can be an additive manufacturing system, e.g., a three-dimensional printer, in which a portion of a material 12 (illustrated initially as small circles) is joined, melted, solidified, and/or fused together in a series of material layers 13 (illustrated as dashed horizontal lines) to manufacture one or more three-dimensional object(s) 11. In FIG. 1A, the object(s) 11 include a plurality of small squares that represent the joining of the material 12 to form the object 11.

The type of three-dimensional object(s) 11 manufactured with the processing machine 10 may be almost any shape or geometry. As a non-exclusive example, the three-dimensional object 11 may be a metal part, or another type of part, for example, a resin (plastic) part or a ceramic part, etc. The three-dimensional object 11 may also be referred to as a “built part”.

The type of material 12 joined and/or fused together may be varied to suit the desired properties of the object(s) 11. As a non-exclusive example, the material 12 may include metal powder grains (e.g., including one or more of titanium, aluminum, vanadium, chromium, copper, stainless steel, or other suitable metals) or alloys for metal three-dimensional printing. Alternatively, the material 12 may be non-metal material, a plastic, polymer, glass, ceramic material, organic material, an inorganic material, or any other material known to people skilled in the art. The material 12 may also be referred to as “powder” or “powder particles”.

A number of different designs of the processing machine 10 are provided herein. In certain implementations, the processing machine 10 includes (i) a material bed assembly 14; (ii) a pre-heat device 16 (illustrated as a box); (iii) a material supply device 18 (illustrated as a box); (iii) a measurement device 20 (illustrated as a box); (iv) an energy system 22 (illustrated as a box); and (v) a control system 24 (illustrated as a box) that cooperate to make each three-dimensional object 11. Additionally, as shown in FIG. 1A, the material bed assembly 14 can include a material bed 26, one or more build beds 28 (two are shown in FIG. 1A) that are coupled to and/or are formed into the material bed 26, and a build area cover assembly 30 having features of the present invention that is configured to selectively cover and/or uncover a portion of each of the build beds 28. The design of each of these components may be varied pursuant to the teachings provided herein. Further, the positions of the components of the processing machine 10 may be different than that illustrated in FIG. 1A. Moreover, the processing machine 10 can include more components or fewer components than illustrated in FIG. 1A. For example, in certain non-exclusive alternative implementations, the processing machine 10 can further include a cooling device (not shown in FIG. 1A) that uses radiation, conduction, and/or convection to cool the newly melted material 12 to a desired temperature. Alternatively, for example, the processing machine 10 can be designed without the pre-heat device 16 and/or the measurement device 20.

The number of build beds 28 can be varied. For example, in the implementation shown in FIG. 1A, the material bed assembly 14 includes two separate build beds 28, one for each object 11. With this design, a single object 11 is made in each build bed 28. Alternatively, more than one object 11 may be built in each build bed 28. Still alternatively, the material bed assembly 14 can include more than two build beds 28, e.g., three, four, five or six build beds 28, or only one build bed 28.

Additionally, the number of objects 11 that may be made substantially concurrently may vary according the type of object 11 and the design of the processing machine 10. In the non-exclusive embodiment illustrated in FIG. 1A, two objects 11 are made substantially simultaneously. Alternatively, the processing machine 10 can make more than two objects 11, e.g., three, four, five or six objects 11, substantially simultaneously, or only one object 11 may be made at a time.

Further, in one embodiment, each of the objects 11 is the same design. Alternatively, for example, the processing machine 10 may be controlled so that one or more different types of objects 11 are made substantially simultaneously.

As an overview, the problem of the cost, mass, and difficulty of distributing and recycling large amounts of material 12 onto a material bed assembly 14 and/or a build bed 28 of a processing machine 10 such as a three-dimensional printer is solved by providing the build area cover assembly 30 that is controlled to selectively control an opening 32 (illustrated in FIG. 1B) onto each of the build beds 28 so as to define a variable material deposition area 34 (illustrated in FIG. 1B) for the build bed 28 so that approximately only an amount of material 12 needed for the object 11 in each material layer 13 is dispensed onto the build bed 28. As shown, the build area cover assembly 30 can be coupled to the material bed 26 and/or the build beds 28. Additionally, the build area cover assembly 30 can be selectively moved relative to the material bed 26 so as to selectively control the opening 32, and thus the variable material deposition area 34, onto each of the build beds 28.

It is appreciated that by reducing the amount of material 12 required for purposes of building the desired objects 11, overall operating costs can also be reduced. Implementations of the processing machine 10 as described herein can further simplify the material 12 deposition and recovery process. Additionally, in certain implementations, the reduction of excess material directly adjacent to the object 11 can make it much easier to separate the object 11, i.e. the built part, from the unused, excess material.

The shape and/or thickness of each material layer 13 can be varied to suit the manufacturing requirements. In one implementation, one or more (e.g., all) of the material layers 13 can have a layer thickness (along the Z axis) of approximately fifty microns. Alternatively, in other non-exclusive examples, one or more (e.g., all) of the material layers 13 can have a layer thickness of approximately twenty, thirty, forty, sixty, seventy, eighty, ninety, or one hundred microns. However other layer thicknesses are possible. In alternative embodiments, the layer thickness for every material layer 13 can be the same, or the layer thickness can vary from material layer 13 to material layer 13. Particle sizes of the material 12 can also be varied. In one implementation, a common particle size is approximately fifty microns. Alternatively, in other non-exclusive examples, the particle size can be approximately twenty, thirty, forty, sixty, seventy, eighty, ninety, or one hundred microns.

A number of Figures include an orientation system that illustrates an X axis, a Y axis that is orthogonal to the X axis, and a Z axis that is orthogonal to the X and Y axes. It should be noted that any of these axes can also be referred to as the first, second, and/or third axes. Further, as used herein, movement with six degrees of freedom shall mean along and about the X, Y, and Z axes.

In FIG. 1A, a portion of the material bed assembly 14 is illustrated in cut-away so that the material 12, the material layers 13 and the object 11 are visible. With the present design, one or more objects 11 can be simultaneously made with the processing machine 10. In FIG. 1A, two objects 11 are visible.

It should be noted that any of the processing machines 10 described herein may be operated in a controlled environment, e.g., such as a vacuum, using an environmental chamber 23 (illustrated in FIG. 1A as a box). For example, one or more of the components of the processing machine 10 can be positioned entirely or partly within the environmental chamber 23. Alternatively, at least a portion of one or more of the components of the processing machine 10 may be positioned outside the environmental chamber 23. Still alternatively, the processing machine 10 may be operated in a non-vacuum environment such as an inert gas (e.g., nitrogen gas or argon gas) environment.

FIG. 1B is a simplified schematic top view illustration of a portion of the processing machine 10 illustrated in FIG. 1A. More particularly, FIG. 1B is a simplified schematic top view illustration of a portion of the material bed assembly 14 of FIG. 1A including the material bed 26 and two build beds 28 (illustrated partially in phantom) that are coupled to and/or are formed into the material bed 26, and two three-dimensional objects 11, with one three-dimensional object 11 being formed on each of the build beds 28. FIG. 1B also illustrates (i) the pre-heat device 16 (illustrated as box) and a pre-heat zone 16A (illustrated in phantom) which represents the approximate area in which the material 12 can be pre-heated with the pre-heat device 16; (ii) the material supply device 18 (illustrated as a box) and a deposit zone 18A (illustrated in phantom) which represents the approximate area in which the material 12 can be added and/or spread to the material bed assembly 14 by the material supply device 18; (iii) the measurement device 20 (illustrated as a box) and a measurement zone 20A (illustrated in phantom) which represents the approximate area in which the material 12 and/or the object 11 can be measured by the measurement device 20; and (iv) the energy system 22 (illustrated as a box) and an energy zone 22A (illustrated in phantom) which represents the approximate area in which the material 12 can be melted and fused together by the energy system 22. It should be noted that these zones may be spaced apart differently, oriented differently, or positioned differently from the non-exclusive example illustrated in FIG. 1B. Additionally, the relative sizes of the zones 16A, 18A, 20A, 22C may be different than what is illustrated in FIG. 1B.

In the implementation illustrated in FIGS. 1A and 1B, the material bed 26 supports the one or more build beds 28, the material 12 and the object(s) 11 while the object(s) 11 are being formed. In the simplified schematic illustrated in FIGS. 1A and 1B, the material bed 26 includes a support platform 26A having an upper platform surface 26B, a side support wall 26C, and a lower support wall 26D. In this embodiment, the support platform 26A is generally flat, disk-shaped and includes the upper platform surface 26B that is generally flat, circular-shaped, the lower support wall 26D that is also flat, disk-shaped, and the side support wall 26C that is tubular-shaped and extends substantially vertically adjacent a perimeter of the lower support wall 26D.

In another implementation, the support platform 26A is generally flat, rectangular-shaped and includes the upper platform surface 26B that is generally flat, rectangular-shaped, the lower support wall 26D that is also flat rectangular-shaped, and the side support wall assembly 26C that is rectangular tube-shaped and extends upward from the lower support wall 26D. Alternatively, other shapes of the support platform 26A, the upper platform surface 26B, the lower support wall 26D and/or side support wall 26C may be utilized. As non-exclusive examples, the support platform 26A and/or the lower support wall 26D can be polygonal-shaped, with the side support wall 26C having a corresponding tubular-shape.

Additionally, as illustrated, the material bed assembly 14 further includes a first platform mover 36 (e.g., one or more actuators) that selectively moves (e.g., rotates) the material bed 26 and/or the support platform 26A. In FIG. 1A, the first platform mover 36 includes a motor 36A (e.g., a rotary motor) and a device connector 36B (e.g., a rigid shaft) that fixedly connects the motor 36A to the material bed 26. In other embodiments, the device connector 36B may include a transmission device such as at least one gear, belt, chain, or friction drive. In this implementation, the first platform mover 36 rotates the material bed 26 in a platform moving (rotation) direction 36C (e.g., counter-clockwise, illustrated by an arrow) about a platform rotation axis 36D (positioned at a rotational center of the material bed 26 and/or the support platform 26A, and illustrated with a “+”, e.g., extending along and/or parallel to the Z axis) relative to one or more of the pre-heat device 16 (and the pre-heat zone 16A), the material supply device 18 (and the deposit zone 18A), the measurement device 20 (and the measurement zone 20A), and the energy system 22 (and the energy zone 22C). This allows nearly all of the rest of the components of the processing machine 10 to be fixed while the material bed 26 and/or the support platform 26A is moved. Additionally, because the material bed 26 is constantly moving, the material 12 may be deposited and fused relatively quickly. This allows for the faster forming of the objects 11, increased throughput of the processing machine 10, and reduced cost for the objects 11.

Thus, in certain implementations, with the build beds 28 being coupled to and/or formed into the material bed 26, the processing machine 10 can be operated so that there is substantially constant motion in the platform moving direction 36C of the build beds 28 and the object(s) 11 being formed relative to one or more of the pre-heat device 16, the material supply device 18, the measurement device 20, and the energy system 22.

In certain implementations, the first platform mover 36 can move the material bed 26 and/or the support platform 26A, and thus the build beds 28, at a substantially constant angular velocity in the platform moving direction 36C about the platform rotation axis 36D, e.g., relative to the pre-heat device 16, the material supply device 18, the measurement device 20, and the energy system 22. As alternative, non-exclusive examples, the first platform mover 36 may move the material bed 26 and/or the support platform 26A, and thus the build beds 28, at a substantially constant angular velocity of at least approximately 0.1, 0.5, 1, 2, 3, 5, 7, 10, 15, 20, 25, 30, 60, or more revolutions per minute (RPM). Stated in a different fashion, the first platform mover 30 may move the material bed 26 and/or the support platform 26A, and thus the build beds 28, at a substantially constant angular velocity of between 0.1 and 60 revolutions per minute. As used herein, the term “substantially constant angular velocity” shall mean a velocity that varies less than 10% over time. In one embodiment, the term “substantially constant angular velocity” shall mean a velocity that varies less than 0.2% from a target velocity.

As noted above, the material 12 used to make the object 11 is deposited onto the material bed 26 and/or the build bed(s) 28 in a series of material layers 13. Depending upon the design of the processing machine 10, the material bed assembly 14 with the material 12 may be very heavy. With the present design, this large mass may be rotated at a constant or substantially constant speed to avoid accelerations and decelerations, and the required motion is a continuous rotation of a large mass, with no non-centripetal acceleration other than at the beginning and end of the entire exposure process. The exposure process may be performed during the period when the motion is constant velocity motion.

Additionally, or alternatively, the first platform mover 36 may move the material bed 26 and/or the support platform 26A, and thus the build beds 28, at a variable velocity or in a stepped or other fashion. For example, it may be desired to speed up or slow down the rotation of the material bed 26 and/or the support platform 26A for some sections, either as part of a normal cycle like increased time under the pre-heat device 16, or as a smart corrective action during the build process (e.g., to repair a defect). The platform rotation axis 36D may be aligned along a gravity direction, and may be along with an inclination direction about the gravity direction.

Further, in some implementations, the support platform 26A can also be moved somewhat similar to a piston relative to the side support wall 26C which acts as the piston's cylinder wall. For example, a second platform mover (e.g., one or more actuators, not shown) can selectively move the support platform 26A downward as each subsequent material layer 13 is added. In certain implementations, the material bed 26 and/or the support platform 26A may be moved down with the second platform mover along the platform rotation axis 36D in a continuous rate via a fine pitch screw or some equivalent method. As provided herein, it is desired to maintain a height 38 between the most recent, upper (top) material layer 13U and the material supply device 18 (and other components) substantially constant for the entire process. In certain embodiments, this can be accomplished by vertical movement of the support platform 26A and/or vertical movement of the build bed 28 relative to the support platform 26A.

Still further, and/or additionally, the material bed assembly 14 can also be moved linearly, e.g. along the X axis and/or along the Y axis relative to the material supply assembly 18, with an assembly mover (e.g., one or more actuators, not shown).

In one implementation, only the material bed 26 is primarily moved, while the pre-heat device 16, the material supply device 18, the measurement device 20, and the energy system 22 are all fixed, making the overall system simpler. Also, the throughput of a rotary-based material bed 26 system is much higher since one or more steps can be performed in parallel rather than serially.

In the non-exclusive example in FIG. 1A, the pre-heat device 16, the material supply device 18, the measurement device 20, and the energy system 22 may be fixed together and retained by a common component housing 40. Collectively these components may be referred to as a top assembly. Additionally, in one non-exclusive alternative embodiment, the processing machine 10 can further include a housing mover 42 (e.g., one or more actuators) that can be controlled to selectively move the top assembly. With this design, the common component housing 40 may be rotated along the platform moving direction 36C or an opposite direction of the platform moving direction 36C. Additionally, with such design, it can be desired that the relative rotational movement between the material bed 26 and the top assembly is at a specific desired angular velocity. Still further, and/or alternatively, the housing mover 42 may be configured to move the top assembly (or a portion thereof) upward a continuous (or stepped) rate while the material 12 is being deposited to help maintain the desired height 38. It is merely appreciated that in alternative implementations, the relative angular velocity between the material bed 26 and the top assembly is maintained at a desired value, and the desired height 38 between the upper material layer 13U and the top assembly is also maintained.

It should be noted that the processing machine 10 can be designed to have one or more of the following features: (i) one or more of the pre-heat device 16, the material supply device 18, the measurement device 20, and the energy system 22 can be selectively moved relative to the component housing 40 and/or the material bed 26 with one or more of the six degrees of freedom; (ii) the component housing 40 with one or more of the pre-heat device 16, the material supply device 18, the measurement device 20, and the energy system 22 can be selectively moved relative to the material bed 26 with one or more of the six degrees of freedom; and/or (iii) the material bed 26 can be selectively moved relative to the component housing 30 with one or more of the six degrees of freedom.

It is appreciated that although the processing machine 10 is generally described herein as including relative rotational movement between the material bed 26 and the top assembly, such description is not intended to be limiting in any manner. For example, in certain alternative embodiments, the processing machine 10 can be configured to additionally and/or alternatively include relative linear movement between the material bed 26 and the top assembly. Still alternatively, in still other embodiments, the processing machine 10 can also include relative movement only in the Z direction between the material bed 26 and the top assembly.

Additionally, in the implementation illustrated in FIGS. 1A and 1B, the one or more build beds 28 support at least a portion of the material 12 and the object(s) 11 while the object(s) 11 are being formed. More particularly, as provided herein, each of the build beds 28 defines a separate, discrete build region. Additionally, as shown, in certain embodiments, the build bed(s) 28 can be embedded into the material bed 26 such that the build bed 28 is movable relative to the material bed 26 and/or the support platform 26A.

In the simplified schematic illustrated in FIGS. 1A and 1B, each build bed 28 includes a movable bed surface 28A, and a bed side wall 28B. In this embodiment, the movable bed surface 28A is flat, rectangular-shaped, and the bed side wall 28B is rectangular tube-shaped and extends substantially vertically adjacent a perimeter of the bed surface 28A to provide an open container type design. The bed side wall 28B can be configured so as to prevent unwanted material 12 from falling outside the bed side wall 28B as material 12 is deposited onto the bed surface 28A. In alternative embodiments, the material supply device 18 includes features that allow the material 12 distribution to start and stop at appropriate times so that substantially all of the material 12 is deposited inside the build bed 28. In another implementation, the bed side wall 28B can be built concurrently as a custom shape around the object 11, while the object 11 is being built. Still alternatively, the build beds 28 can be configured without the bed side wall 28B. Yet alternatively, the build bed 28 can have another suitable shape, e.g., circular disk-shaped or other polygonal shape.

Additionally, in certain embodiments, the bed surface 28A of each build bed 28 can be moved somewhat like an elevator vertically (parallel to the platform rotation axis 36D) relative to its respective bed side wall 28B with a bed mover 28C (e.g., one or more actuators) during fabrication of the objects 11. In such embodiments, fabrication can begin with the bed surface 28A placed near a top of the bed side wall 28B. The material supply device 18 deposits material 12 in a series of thin material layers 13 into each build bed 28 as the build bed 28 is moved below the material supply device 18. In particular, the material supply device 18 initially deposits material 12 onto the bed surface 28A. This creates an upper material layer 13U directly onto the bed surface 28A. As each subsequent material layer 13 is deposited, the upper material layer 13U changes, with a new upper material layer 13U formed onto the previous upper material layer 13U. During such process, at an appropriate time, the bed surface 28A in each build bed 28 is stepped down via the bed mover 28C by one layer thickness so the next layer of material 12 may be distributed properly. As utilized herein, the bed surface 28A for the initial material layer 13, and then the upper material layer 13U as each new material layer 13 is being added on top of the previous material layer 13 can also be referred to generally as a build surface 29.

In certain implementations, the build bed 28 and/or the bed surface 28A may be moved down with the bed mover 28C parallel to the platform rotation axis 36D in a continuous rate via a fine pitch screw or some equivalent method. With such design, the height 38 between the most recent, upper (top) material layer 13U and the material supply device 18 (and other components) may be maintained substantially constant for the entire process. Alternatively, the build bed 28 and/or the bed surface 28A may be moved down in a step down fashion at each rotation, which could lead to the possibility of a discontinuity at one radial position in the build bed 28. As used herein, “substantially constant” shall mean the height 38 varies by less than a factor of three, since the typical thickness of each material layer is less than one millimeter. In another embodiment, “substantially constant” may mean the height 38 varies less than ten percent of the height 38 during the manufacturing process.

The pre-heat device 16 selectively preheats the material 12 in the pre-heat zone 16A that has been deposited on the material bed 26 and/or the build beds 28 during a pre-heat time. In certain embodiments, the pre-heat device 16 heats the material 12 to a desired preheated temperature in the pre-heat zone 16A when the material 12 is moved through the pre-heat zone 16A. The number of the pre-heat devices 16 may be one or plural.

In one embodiment, the pre-heat device 16 is positioned along a pre-heat axis (direction) 16B. Additionally, in certain alternative implementations, the pre-heat device 16 can be positioned in any suitable manner relative to the material supply device 18, the measurement device 20 and the energy system 22.

The design of the pre-heat device 16 and the desired preheated temperature may be varied. In one embodiment, the pre-heat device 16 may include one or more pre-heat energy source(s) 16C that direct one or more pre-heat beam(s) 16D at the material 12. Each pre-heat beam 16D may be steered as necessary. As alternative, non-exclusives examples, each pre-heat energy source 16C may be an electron beam system, a mercury lamp, an infrared laser, a supply of heated air, a thermal radiation system, a visual wavelength optical system, or a microwave optical system. The desired preheated temperature may be 50%, 75%, 90%, or 95% of the melting temperature of the material 12 used in the printing. It is understood that different materials have different melting points and therefore different desired pre-heating points. As non-exclusive examples, the desired preheated temperature may be at least 300, 500, 700, 900, or 1000 degrees Celsius. Energy input may also vary dependent on melt duty of previous layers, specific regions on a layer, or progress though the build process.

The material supply device 18 deposits the material 12 onto the material bed 26 and/or onto the build beds 28. In certain embodiments, the material supply device 18 supplies the material 12 to the material bed 26 in the deposit zone 18A during times of relative movement between the material bed 26 and the material supply device 18 to form each material layer 13 on the material bed 26.

The material supply device 18 deposits the material 12 onto the build bed(s) 28 during a material deposition time to sequentially form each material layer 13. With the present design, the material supply device 18 sequentially forms individual material layers 13 on top of the bed surface 28A of the build bed(s) 28, with an initial material layer 13 being formed directly onto the bed surface 28A (i.e. the build surface 29 for this initial material layer 13) at the beginning of the manufacturing process to create an initial upper (top) material layer 13U, then subsequent material layers (new upper material layer 13U) are formed on the previous upper material layer 13U (i.e. also referred to as the build surface 29 as the material 12 is added onto the upper material layer 13U). In certain embodiments, the material supply device 18 supplies the material 12 to the build bed(s) 28 in the deposit zone 18A during times of relative movement between the build bed(s) 28 and the material supply device 18 to form each material layer 13.

In one implementation, the material supply device 18 extends along a material supply axis (direction) 18B. Additionally, in certain alternative implementations, the material supply device 18 can be positioned in any suitable manner relative to the pre-heat device 16, the measurement device 20 and the energy system 22. The material supply device 18 can include one or more material containers (not shown in FIGS. 1A and 1B). The number of the material supply devices 18 may be one or plural.

With the present design, the material supply device 18 deposits the material 12 onto the material bed assembly 14 to sequentially form each material layer 13. Once a portion of the material layer 13 (i.e. the upper material layer 13U) is formed, the energy system 22 directs an energy beam(s) 22D onto a surface of the upper(top) material layer 13U (thereby creating the build surface 29 for the subsequent material layer 13), a part (layer) of the object 11 is built at the build surface 29. Then, the material supply device 18 evenly and uniformly deposits another (subsequent) material layer 13 to form a new upper material layer 13U, and thus a new build surface 29, on the previous build surface 29 on which one layer of the object 11 has been formed. Thus, as described herein, a new build surface 29 is created and used for each subsequent material layer 13 as the object 11 is being built.

In one embodiment, a work member 43 is loaded on the build bed 28 prior to the start of manufacturing of the object 11. In such embodiment, the work member 43 can be a plate-like object that can be made of the same material as the material 12 used in forming the object 11. Additionally, in such embodiment, the material supply device 18 deposits to the work member 43 to form the first material layer of the material 12 onto the work member 43. When building the object 11 is finished, the object 11 is unloaded form the build bed 28 along with the work member 43.

Additionally, as provided herein, in various embodiments, the build area cover assembly 30 can be utilized to selectively control the opening 32 into each of the build beds 28 to define the variable material deposition area 34 within which the material 12 is actually deposited onto the build bed 28 and/or the build surface 29. More particularly, in certain implementations, the build area cover assembly 30 can include one or more assembly members 30A that are selectively movable with one or more member movers 30B (e.g., one or more actuators, illustrated in phantom) to cover at least a portion of the build bed 28. By moving the assembly members 30A to cover at least a portion of the build bed 28, a smaller amount of material will be deposited onto the build bed 28 for that particular material layer 13. In one implementation, the build area cover assembly 30 can include a separate member mover 30B for moving each assembly member 30A. Alternatively, in another implementation, the build area cover assembly 30 can include member movers 30B that are capable of moving more than one of the assembly members 30A. Still alternatively, in still another implementation, the build area cover assembly 30 can include a single member mover 30B that is capable of moving each of the assembly members 30A, either individually or collectively. With this design, in certain implementations, the build area cover assembly 30 (e.g., the member movers 30B) can be selectively controlled by the control system 24 to selective control the size and/or shape of the opening 32, and selectively control the size and/or shape of the material 12 being deposited onto the build beds 28.

It is appreciated that as the object 11 is being built, certain layers of the object 11 will require less material 12 than others to build the object 11 as desired. As such, the desired material layers 13 will not always be the same size. Thus, by depositing only that approximate amount of material 12 onto the build bed 28 that is specifically desired for each material layer 13 (or just a little bit more, rather than substantially completely covering the full maximum size of the build region as defined by the build bed 28), material 12 waste can be minimized. Stated in another manner, by selectively limiting the size of the opening 32 onto the build bed 28 for each material layer 13, and thus by selectively limiting the size of the variable material deposition area 34 accessible for each material layer 13, material 12 waste can be limited.

In certain implementations, the build area cover assembly 30 can be adjusted to selectively adjust the opening 32 and thus the variable material deposition area 34 for each material layer 13 as the object 11 is being built. Alternatively, in other implementations, the build area cover assembly 30 can be adjusted once prior to any building of the object 11 so that the opening 32 defines the variable material deposition area 34 that is the maximum size needed for any individual material layer 13 during the building of the object 11. With such alternative implementations, the build area cover assembly 30 is only set once for each object 11 being built. Still alternatively, in still other implementations, the build area cover assembly 30 can be adjusted prior to any building of the object 11 so that the opening 32 defines the variable material deposition area 34 that is the maximum size needed for any individual material layer 13 during the building of the object 11, but can then be readjusted to the next (smaller) maximum size needed for any subsequent material layers 13 above the maximum size material layers 13. It is appreciated that in such implementations, the build area cover assembly 30 can still be adjusted multiple times, but only as many times as necessary to accommodate the size of the object 11 getting generally smaller toward a top of the object 11.

Additionally, in some implementations, the design of the build area cover assembly 30 can be varied so as to inhibit any of the material 12 from sticking to the assembly members 30A of the build area cover assembly 30 during the build process. For example, in one implementation, the assembly members 30A of the build area cover assembly 30 can be formed from a high-temperature material, e.g., ceramic, tungsten, molybdenum, niobium, etc., so that the material 12 does not stick to such assembly members 30A as the material 12 is being melted during the build process. As used herein, in alternative examples, the term high-temperature material shall mean a material having a melt temperature of at least 1000, 1500, 2000, or more degrees Celsius. In another implementation, the depositing of the material 12 onto the build bed(s) 28 can be controlled such that the material 12 is deposited so as to be slightly spaced apart from the assembly members 30A. As such, with a desired slight spacing between the material 12 and the assembly members 30A, the material 12 is inhibited from sticking to the assembly members 30A as the material 12 is being melted because there is no actual contact between the melted material 12 and the assembly members 30A.

In some implementations, the processing machine 10 can further include a material mover 44, e.g., a rake or other suitable device, capable of distributing and/or leveling each successive material layer 13. As shown, the material mover 44 can be coupled to one or more of the material bed 26, the build bed 28, and the build area cover assembly 30. With such design, to the extent that any material 12 has been deposited on top of the assembly members 30A of the build area cover assembly 30 by the material supply device 18, the material mover 44 can be configured to move such excess material 12 across the top of the assembly members 30A and into at least one material receptacle 46 that can be positioned substantially adjacent to the build bed 28 (two material receptacles 46 are shown positioned substantially adjacent to each build bed 28 (on opposing sides) in the implementation illustrated in FIGS. 1A and 1B). Such excess material 12 that has been moved into the at least one material receptacle 46 can then be removed and reused as desired. Thus, the material mover 44 provides dual functions of distributing and/or leveling each successive material layer 13, and moving any excess material 12 into the material receptacle 46 for possible removal and reuse. In certain other embodiments, the material mover 44 can be supported by the component housing 40.

In the non-exclusive embodiment in FIG. 1A, the material supply device 18 is a single overhead material supply that supplies the material 12 onto the bed surface 28A of the individual build bed(s) 28. Additionally, the material mover 44 can then be utilized to distribute and/or level each sequential material layer 13 as the material is deposited onto the movable bed surface 28A of the individual build bed(s) 28, and/or to move excess material 12 into the material receptacle 46. Alternatively, the material supply device 18 can be designed to include multiple material supplies (at different locations) and/or other ways to distribute/level each sequential material layer 13. Still alternatively, in each of the processing machines 10 disclosed herein, the material supply device 18 can be a table-integrated material supply (not shown) which delivers the material 12 from the side or through the material bed assembly 14, or another type of material supply device.

It should be noted that the three-dimensional object 11 is formed through consecutive fusions of consecutively formed cross-sections of material 12 in one or more material layers 13. For simplicity, the example of FIG. 1A illustrates only a few, separate, stacked material layers 13. However, it should be noted that depending upon the design of the object 11, the building process will require numerous material layers 13.

The measurement device 20 inspects and monitors the melted (fused) layers of the object 11 in the measurement zone 20A during a measurement time as the object 11 is being built, and/or during the deposition of the material layers 13. The number of the measurement devices 20 may be one or plural. For example, the measurement device 20 can measure both before and after the material 12 is distributed. Additionally, the measurement device 20 may inspect the material layer(s) 13 or the object 11 optically, electrically, or physically.

As non-exclusive examples, the measurement device 20 may include one or more optical elements such as a uniform illumination device, fringe illumination device (structured illumination device), cameras that function at one or more wavelengths, lens, interferometer, or photodetector, or a non-optical measurement device such as an ultrasonic, eddy current, or capacitive sensor.

Additionally, in certain alternative implementations, the measurement device 20 can be positioned in any suitable manner relative to the pre-heat device 16, the material supply device 18 and the energy system 22.

The energy system 22 selectively heats and melts the material 12 in the energy zone 22A during a melting time to sequentially form each of the layers of the object 11 while the material bed 26, the build bed(s) 28, and the object 11 are being moved. The energy system 22 can selectively melt the material 12 at least based on data regarding the object 11 to be built. The data may be corresponding to a computer-aided design (CAD) model data. The number of the energy systems 22 may be one or plural.

In one embodiment, the energy system 22 is positioned along an energy axis (direction) 22B. Additionally, in certain alternative implementations, the energy system 22 can be positioned in any suitable manner relative to pre-heat device 16, the material supply device 18 and the measurement device 20.

The design of the energy system 22 can be varied. In one embodiment, the energy system 22 may include one or more energy source(s) 22C (“irradiation systems”) that direct one or more irradiation (energy) beam(s) 22D at the material 12. The one or more energy sources 22C can be controlled to steer the energy beam(s) 22D to melt the material 12.

As alternative, non-exclusives examples, each of the energy sources 22C can be designed to include one or more of the following: (i) an electron beam generator that generates a charged particle electron beam; (ii) an irradiation system that generates an irradiation beam; (iii) an infrared laser that generates an infrared beam; (iv) a mercury lamp; (v) a thermal radiation system; (vi) a visual wavelength system; (vii) a microwave wavelength system; or (viii) an ion beam system.

Different materials 12 have different melting points. As non-exclusive examples, the desired melting temperature may be at least 1000, 1400, 1700, 2000, or more degrees Celsius.

It should be noted that with the design provided herein, multiple operations may be performed at the same time (simultaneously) to improve the throughput of the processing machine 10. Stated in another fashion, one or more of the pre-heat time, the material deposition time, the measurement time, and the melting time may be partly or fully overlapping in time for any given processing of a material layer 13 of material 12 to improve the throughput of the processing machine 10. For example, two, three, or all four of these times may be partly or fully overlapping. More specifically, (i) the pre-heat time may be at least partly overlapping with the material deposition time, the measurement time, and/or the melting time; (ii) the material deposition time may be at least partly overlapping with the pre-heat time, the measurement time, and/or the melting time; (iii) the measurement time may be at least partly overlapping with the material deposition time, the pre-heat time, and/or the melting time; and/or (iv) the melting time may be at least partly overlapping with the material deposition time, the measurement time, and/or the pre-heat time.

The control system 24 controls the components of the processing machine 10 to build the three-dimensional object 11 from the computer-aided design (CAD) model by successively melting portions of one or more of the material layers 13. For example, the control system 24 can control (i) the material bed assembly 14; (ii) the pre-heat device 16; (iii) the material supply device 18; (iii) the measurement device 20; (iv) the energy system 22; and (v) the build area cover assembly 30. The control system 24 can be a centralized or a distributed system.

The control system 24 may include, for example, a CPU (Central Processing Unit) 24A, a GPU (Graphics Processing Unit) 24B, and electronic memory 24C. The control system 24 functions as a device that controls the operation of the processing machine 10 by the CPU executing the computer program. This computer program is a computer program for causing the control system 24 (for example, a CPU) to perform an operation to be described later to be performed by the control system 24 (that is, to execute it). That is, this computer program is a computer program for making the control system 24 function so that the processing machine 10 will perform the operation to be described later. A computer program executed by the CPU may be recorded in a memory (that is, a recording medium) included in the control system 24, or an arbitrary storage medium built in the control system 24 or externally attachable to the control system 24, for example, a hard disk or a semiconductor memory. Alternatively, the CPU may download a computer program to be executed from a device external to the control system 24 via the network interface. Further, the control system 24 may not be disposed inside the processing machine 10, and may be arranged as a server or the like outside the processing machine 10, for example. In this case, the control system 24 and the processing machine 10 may be connected via a communication line such as a wired communications line (cable communications), a wireless communications line, or a network. In case of physically connecting with a wired communications line, it is possible to use serial connection or parallel connection of IEEE1394, RS-232x, RS-422, RS-423, RS-485, USB, etc. or 10BASE-T, 100BASE-TX, 1000BASE-T or the like via a network. Further, when connecting using radio, radio waves such as IEEE 802.1x, OFDM, or the like, radio waves such as Bluetooth (registered trademark), infrared rays, optical communication, and the like may be used. In this case, the control system 24 and the processing machine 10 may be configured to be able to transmit and receive various types of information via a communication line or a network. Further, the control system 24 may be capable of transmitting information such as commands and control parameters to the processing machine 10 via the communication line and the network. The processing machine 10 may include a receiving device (receiver) that receives information such as commands and control parameters from the control system 24 via the communication line or the network. As a recording medium for recording the computer program executed by the CPU, a CD-ROM, a CD-R, a CD-RW, a flexible disk, an MO, a DVD-ROM, a DVD-RAM, a DVD-R, a DVD+R, a DVD-RW, a magnetic medium such as a magnetic disk and a magnetic tape such as DVD+RW and Blu-ray (registered trademark), a semiconductor memory such as an optical disk, a magneto-optical disk, a USB memory, or the like, and a medium capable of storing other programs. In addition to the program stored in the recording medium and distributed, the program includes a form distributed by downloading through a network line such as the Internet. Further, the recording medium includes a device capable of recording a program, for example, a general-purpose or dedicated device mounted in a state in which the program can be executed in the form of software, firmware or the like. Furthermore, each processing and function included in the program may be executed by program software that can be executed by a computer, or processing of each part may be executed by hardware such as a predetermined gate array (FPGA, ASIC) or program software, and a partial hardware module that realizes a part of hardware elements may be implemented in a mixed form.

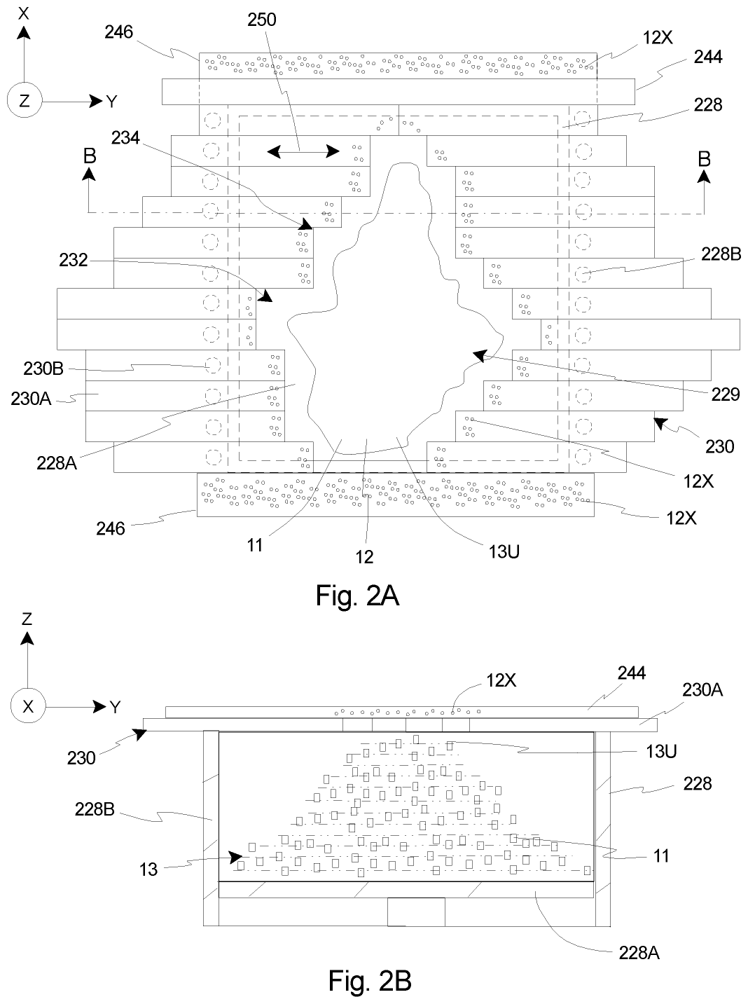

FIG. 2A is a simplified schematic top view illustration of a build bed 228 (illustrated partially in phantom) and an implementation of the build area cover assembly 230. Additionally, FIG. 2A further illustrates (i) the object 11 and/or the upper material layer 13U that is being used to form a portion of the object 11, positioned on the build bed 228; (ii) at least one material receptacle 246 (two material receptacles 246 are illustrated in FIG. 2A) that can be positioned substantially adjacent to the build bed 228 to receive any excess material 12X (illustrated as small circles) that has been deposited on top of the build area cover assembly 230; and (iii) a material mover 244, e.g., a rake or other suitable device, that can be used to distribute and/or level the upper material layer 13U as it is deposited onto the build bed 228 and/or to move the excess material 12X that has been deposited on top of the build area cover assembly 230 into the material receptacles 246.

The build bed 228 is configured to support at least a portion of the material 12 and the object 11 while the object 11 is being formed. As such, the build bed 228 defines a specific maximum build region for the object 11. As illustrated, the build bed 228 includes a bed surface 228A upon which the material 12 is deposited and the object 11 is built, and a bed side wall 228B. In the embodiment illustrated in FIG. 2A, the bed surface 228A is substantially flat, rectangular-shaped, and the bed side wall 228B is substantially rectangular tube-shaped and extends substantially vertically adjacent a perimeter of the bed surface 228A. In some embodiments, the bed side wall 228B can be configured so as to prevent unwanted material 12 from falling outside the bed side wall 228B as material 12 is deposited onto the bed surface 228A. In another implementation, the bed side wall 228B can be built concurrently as a custom shape around the object 11, while the object 11 is being built. Alternatively, the build bed 228 can be configured without the bed side wall 228B, and/or the build bed 228 can have another suitable shape, e.g., circular disk-shaped or other polygonal shape.

The build area cover assembly 230 is configured to selectively control a size and/or shape of an opening 232 into the build bed 228 to define a variable material deposition area 234 within which the material 12 is actually deposited onto the build bed 228 and/or the build surface 229. In certain implementations, the build area cover assembly 230 can include one or more assembly members 230A that are selectively and individually movable relative to each other with one or more member movers 230B (e.g., one or more actuators, illustrated in phantom) to cover at least a portion of the build bed 228 and/or the build surface 229 so as to control a size and shape of the material deposition area 234 of the build surface 229. In the implementation illustrated in FIG. 2A, the build area cover assembly 230 includes a plurality of assembly members 230A that are provided in the form of individually controllable thin plates or “fingers”, which can be individually moved with the member movers 230B so that each assembly member 230A can cover a portion of the build bed 228 and/or the build surface 229. With such design, the selective and individual moving of each of the assembly members 230A to effectively cover a portion of the build bed 228 establishes a smaller opening 232 onto the build bed 228 and/or a smaller material deposition area 234 than the maximum build region for the object 11. As shown in this implementation, each of the assembly members 230A can be moved back-and-forth in a direction as indicated by two-headed arrow 250 to selectively cover and/or uncover a portion of the build bed 228 and/or the build surface 229 depending on the size of the upper material layer 13U needed to build the desired object 11 having the desired size.

It should be noted that any of the member movers 230B can be referred to as first, second, third, fourth, etc., member mover. Further, one or more of the member movers 230B can include one or more linear, rotary or other type of actuator.

By moving the assembly members 230A to cover at least a portion of the build bed 228, a smaller amount of material 12 will be deposited onto the build bed 228 for that particular material layer 13. In one implementation, the build area cover assembly 230 can include a separate member mover 230B for moving each assembly member 230A. Alternatively, in another implementation, the build area cover assembly 230 can include member movers 230B that are capable of moving more than one of the assembly members 230A. Still alternatively, in still another implementation, the build area cover assembly 230 can include a single member mover 230B that is capable of moving each of the assembly members 230A, either individually or collectively. In alternative embodiments the member mover(s) 230B may be supported by any of the build bed 228, the material bed 26, or the component housing 40.

The build area cover assembly 230 can include any suitable number of assembly members 230A. For example, in one embodiment, the build area cover assembly 230 includes twenty-four (24) total assembly members 230A, with twelve individual assembly members 230A that can be positioned to extend over a portion of the build bed 228 from each of two opposing sides of the build bed 228. Alternatively, the build area cover assembly 230 can include more than twenty-four (24) or fewer than twenty-four (24) assembly members 230A and/or the assembly members 230A can be positioned in a different manner from what is illustrated in FIG. 2A. For example, in one non-exclusive alternative embodiment, the build area cover assembly 230 can include a plurality of assembly members 230A that extend over a portion of the build bed 228 from only one side of the build bed 228. It should be noted that any of the assembly members 230A can be referred to as first, second, third, fourth, etc., assembly member.

Additionally, the assembly members 230A can be formed from any suitable materials. In certain implementations, the assembly members 230A can be formed from materials so as to inhibit any of the material 12 from sticking to the assembly members 230A during the build process. For example, in one implementation, the assembly members 230A can be formed from a high-temperature material, e.g., ceramic, tungsten, molybdenum, niobium, etc., so that the material 12 does not stick to such assembly members 230A as the material 12 is being melted during the build process.

It is appreciated that as the object 11 is being built, certain layers of the object 11 will require less material 12 than others to build the object 11 as desired. As such, the desired material layers 13 will not always be the same size. Thus, by depositing only that amount of material 12 onto the build bed 228 that is specifically desired for each material layer 13 (or just a little bit more), material 12 waste can be minimized. Stated in another manner, by selectively limiting the size of the opening 232 onto the build bed 228 for each material layer 13 with the build area cover assembly 230, and thus by selectively limiting the size of the variable material deposition area 234 accessible for each material layer 13, material 12 waste can be limited.

In certain implementations, the assembly members 230A of the build area cover assembly 230 can be moved and/or adjusted to selectively adjust the opening 232 and thus the variable material deposition area 234 for each material layer 13 as the object 11 is being built. Alternatively, in other implementations, the assembly members 230A of the build area cover assembly 230 can be moved and/or adjusted only once, prior to any building of the object 11, so that the opening 232 defines the variable material deposition area 234 that is the maximum size needed for any individual material layer 13 during the building of the object 11. With such alternative implementations, the assembly members 230A of the build area cover assembly 230 are only set once for each object 11 being built. Still alternatively, in still other implementations, the assembly members 230A of the build area cover assembly 230 can be moved and/or adjusted prior to any building of the object 11 so that the opening 232 defines the variable material deposition area 234 that is the maximum size needed for any individual material layer 13 during the building of the object 11, but can then be moved and/or readjusted to the next (smaller) maximum size needed for any subsequent material layers 13 above the maximum size material layers 13. It is appreciated that in such implementations, the assembly members 230A of the build area cover assembly 230 can still be moved and/or adjusted multiple times, but only as many times as necessary to accommodate the size of the object 11 getting generally smaller toward a top of the object 11.

It is further appreciated that in some implementations, the depositing of the material 12 onto the build bed 228 can be controlled such that the material 12 is deposited so as to be slightly spaced apart from the assembly members 230A. As such, with a desired slight spacing between the material 12 and the assembly members 230A, the material 12 is inhibited from sticking to the assembly members 230A as the material 12 is being melted because there is no actual contact between the melted material 12 and the assembly members 230A.

As illustrated, the material receptacles 246 can be positioned substantially adjacent to the build bed 228. The material receptacles 246 are configured to receive and retain the excess material 12X that has been deposited onto the top of the assembly members 230A of the build area cover assembly 230. Additionally, in some implementations, the material receptacles 246 can be removable so that the excess material 12X can be quickly and easily removed and reused as desired.

The material mover 244 can be coupled to one or more of the material bed 26 (illustrated in FIG. 1A), the build bed 228, and the build area cover assembly 230. The material mover 244 is configured to distribute and/or level each successive material layer 13 that has been deposited onto the build bed 228. Additionally, the material mover 244 can be further configured to move any material 12 that has been deposited on top of the assembly members 230A of the build area cover assembly 230 by the material supply device 18 (illustrated in FIG. 1A) across the top of the assembly members 230A and into one of the material receptacles 246. Such excess material 12X that has been moved into the material receptacle 246 can then be removed and reused as desired.

FIG. 2B is a simplified schematic side view illustration of the build bed 228 and the build area cover assembly 230 taken on line B-B in FIG. 2A. More particularly, FIG. 2B illustrates the bed surface 228A and the bed side walls 228B of the build bed 228, and the assembly members 230A of the build area cover assembly 230. The member movers 230B of the build area cover assembly 230 are not illustrated in FIG. 2B for purposes of clarity.

Additionally, FIG. 2B further illustrates the object 11, various material layers 13, including upper material layer 13U, that are joined, melted, solidified, and/or fused together to form the object 11, excess material 12X that has been deposited on top of the assembly members 230A of the build area cover assembly 230, and the material mover 244 that can be used to distribute and/or level each successive material layer 13, and/or to move the excess material 12X into the material receptacles 246 (illustrated in FIG. 2A).

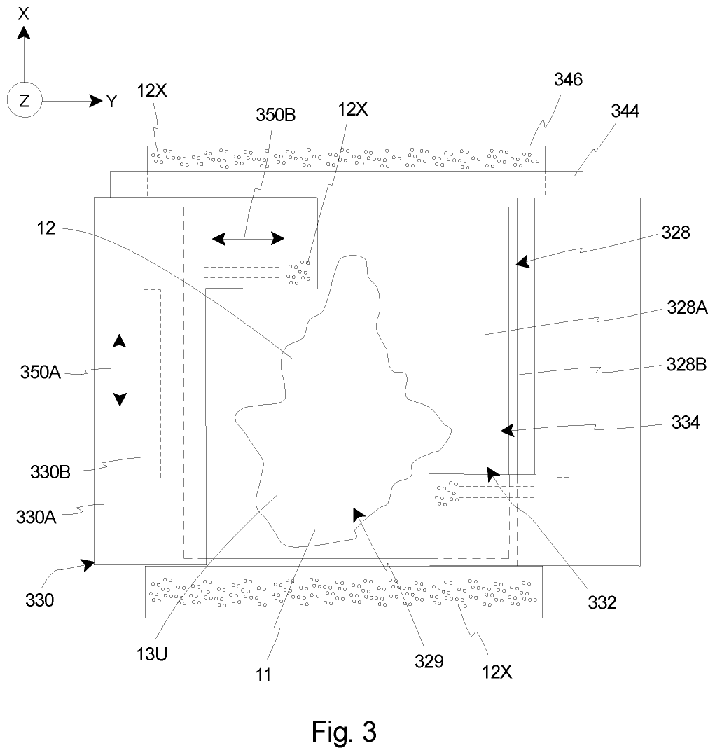

FIG. 3 is a simplified schematic top view illustration of a build bed 328 (illustrated partially in phantom) and another implementation of the build area cover assembly 330. Additionally, FIG. 3 further illustrates (i) the object 11 and/or the upper material layer 13U that is being used to form a portion of the object 11, positioned on the build bed 328; (ii) at least one material receptacle 346 (two material receptacles 346 are illustrated in FIG. 3) that can be positioned substantially adjacent to the build bed 328 to receive any excess material 12X (illustrated as small circles) that has been deposited on top of the build area cover assembly 330; and (iii) a material mover 344, e.g., a rake or other suitable device, that can be used to distribute and/or level the upper material layer 13U as it is deposited onto the build bed 328 and/or to move the excess material 12X that has been deposited on top of the build area cover assembly 330 into the material receptacles 346.

Similar to previous embodiments, the build bed 328 is again configured to support at least a portion of the material 12 and the object 11 while the object 11 is being formed. Additionally, the build bed 328 again includes a bed surface 328A upon which the material 12 is deposited and the object 11 is built, and a bed side wall 328B. In the embodiment illustrated in FIG. 3, the bed surface 328A is substantially flat, rectangular-shaped, and the bed side wall 328B is substantially rectangular tube-shaped and extends substantially vertically adjacent a perimeter of the bed surface 328A. In some embodiments, the bed side wall 328B is configured to prevent unwanted material 12 from falling outside the bed side wall 328B as the material 12 is deposited onto the bed surface 328A. In another implementation, the bed side wall 328B can be built concurrently as a custom shape around the object 11, while the object 11 is being built. Alternatively, the build bed 328 can have another suitable design and/or shape.

As above, the build area cover assembly 330 is again configured to selectively control an opening 332 onto the build bed 328 to define a variable material deposition area 334 within which the material 12 is actually deposited onto the build bed 328 and/or the build surface 329. Stated in another manner, the build area cover assembly 330 is again configured to selectively control a size and shape of the material deposition area 334 of the build surface 329. However, in this embodiment, the build area cover assembly 330 has a different design than in the previous embodiments. More particularly, in such embodiment, the material deposition area 334 as defined by the variable positioning of the build area cover assembly 330 is always a rectangle defined by a simpler mechanism than in previous embodiments. For example, in the embodiment illustrated in FIG. 3, the build area cover assembly 330 includes a pair of substantially L-shaped assembly members 330A that are each configured to selectively cover and/or uncover a portion of the build bed 328 and/or the build surface 329. In one implementation, it is appreciated that the L-shaped assembly members 330A need to be large enough that they always overlap so as to effectively define a rectangular-shaped opening 332.

In this embodiment, the assembly members 330A are each selectively movable back-and-forth in a first direction 350A (as illustrated by a two-headed arrow) and back-and-forth in a second direction 350B (as illustrated by a two-headed arrow) that is orthogonal to the first direction 350A by one or more member movers 330B (e.g., one or more actuators, illustrated in phantom). In some implementations, with such design, the assembly members 330A can define an adjustable, substantially rectangular material deposition area 334. In other implementations, as shown, the assembly members 330A can define an adjustable, variable material deposition area 334 that includes more than four sides. As shown in this implementation, each of the assembly members 330A can be moved back-and-forth in the first direction 350A and/or the second direction 350B to selectively cover and/or uncover a portion of the build bed 328 and/or the build surface 329 depending on the size of the upper material layer 13U needed to build the desired object 11 having the desired size.

It is appreciated that the build area cover assembly 330 can have any suitable number of member movers 330B so that each of the assembly members 330A can be moved back-and-forth in the first direction 350A and/or the second direction 350B. For example, an embodiment with three assembly members 330A can produce different shapes and sizes of a hexagonal opening 332. In other embodiments, other polygonal shapes can be used for the opening 332. In one embodiment, a separate member mover 330B is included for moving each of the assembly members 330A in each of the first direction 350A and the second direction 350B. In another embodiment, a single member mover 330B is included for moving each of the assembly members 330A in both the first direction 350A and the second direction 350B. In still another embodiment, a single member mover 330B can move both assembly members 330A in both the first direction 350A and the second direction 350B.

As with the previous embodiments, the assembly members 330A can be formed from any suitable materials. In certain implementations, the assembly members 330A can be formed from materials so as to inhibit any of the material 12 from sticking to the assembly members 330A during the build process. For example, in one implementation, the assembly members 330A can be formed from a high-temperature material, e.g., ceramic, tungsten, molybdenum, niobium, etc., so that the material 12 does not stick to such assembly members 330A as the material 12 is being melted during the build process.

It is appreciated that as the object 11 is being built, certain layers of the object 11 will require less material 12 than others to build the object 11 as desired. As such, the desired material layers 13 will not always be the same size. Thus, by depositing only that amount of material 12 onto the build bed 328 that is specifically desired for each material layer 13 (or just a little bit more), material 12 waste can be minimized. Stated in another manner, by selectively limiting the size of the opening 332 onto the build bed 328 for each material layer 13 with the build area cover assembly 330, and thus by selectively limiting the size of the variable material deposition area 334 accessible for each material layer 13, material 12 waste can be limited.

In certain implementations, the assembly members 330A of the build area cover assembly 330 can be moved and/or adjusted to selectively adjust the opening 332 and thus the variable material deposition area 334 for each material layer 13 as the object 11 is being built. Alternatively, in other implementations, the assembly members 330A of the build area cover assembly 330 can be moved and/or adjusted once prior to any building of the object 11 so that the opening 332 defines the variable material deposition area 334 that is the maximum size needed for any individual material layer 13 during the building of the object 11. With such alternative implementations, the assembly members 330A of the build area cover assembly 330 are only set once for each object 11 being built. Still alternatively, in still other implementations, the assembly members 330A of the build area cover assembly 330 can be adjusted prior to any building of the object 11 so that the opening 332 defines the variable material deposition area 334 that is the maximum size needed for any individual material layer 13 during the building of the object 11, but can then be moved and/or readjusted to the next (smaller) maximum size needed for any subsequent material layers 13 above the maximum size material layers 13. It is appreciated that in such implementations, the assembly members 330A of the build area cover assembly 330 can still be moved and/or adjusted multiple times, but only as many times as necessary to accommodate the size of the object 11 getting generally smaller toward a top of the object 11.

It is further appreciated that in some implementations, the depositing of the material 12 onto the build bed 328 can be controlled such that the material 12 is deposited so as to be slightly spaced apart from the assembly members 330A. As such, with a desired slight spacing between the material 12 and the assembly members 330A, the material 12 is inhibited from sticking to the assembly members 330A as the material 12 is being melted because there is no actual contact between the melted material 12 and the assembly members 330A.

As illustrated, the material receptacles 346 can be positioned substantially adjacent to the build bed 328. The material receptacles 346 are configured to receive and retain the excess material 12X that has been deposited onto the top of the assembly members 330A of the build area cover assembly 330. Additionally, in some implementations, the material receptacles 346 can be removable so that the excess material 12X can be quickly and easily removed and reused as desired.

The material mover 344 can be coupled to one or more of the material bed 26 (illustrated in FIG. 1A), the build bed 328, and the build area cover assembly 330. The material mover 344 is configured to distribute and/or level each successive material layer 13 that has been deposited onto the build bed 328. Additionally, the material mover 344 can be further configured to move any material 12 that has been deposited on top of the assembly members 330A of the build area cover assembly 330 by the material supply device 18 (illustrated in FIG. 1A) across the top of the assembly members 330A and into one of the material receptacles 346. Such excess material 12X that has been moved into the material receptacle 346 can then be removed and reused as desired.

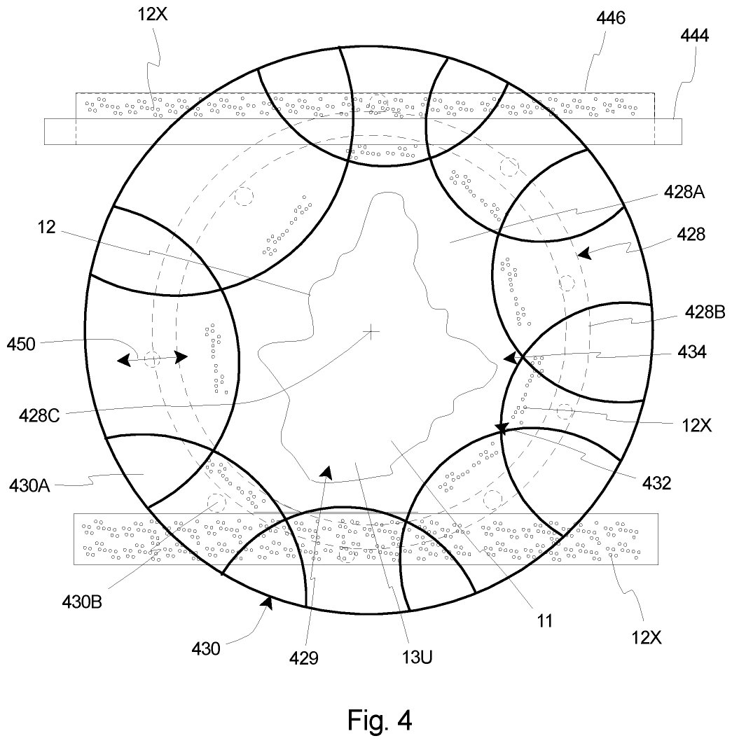

FIG. 4 is a simplified schematic top view illustration of a build bed 428 (illustrated partially in phantom) and still another implementation of the build area cover assembly 430. Additionally, FIG. 4 further illustrates (i) the object 11 and/or the upper material layer 13U that is being used to form a portion of the object 11, positioned on the build bed 428; (ii) at least one material receptacle 446 (two material receptacles 446 are illustrated in FIG. 4) that can be positioned substantially adjacent to the build bed 428 to receive any excess material 12X (illustrated as small circles) that has been deposited on top of the build area cover assembly 430; and (iii) a material mover 444, e.g., a rake or other suitable device, that can be used to distribute and/or level the upper material layer 13U as it is deposited onto the build bed 428 and/or to move the excess material 12X that has been deposited on top of the build area cover assembly 430 into the material receptacles 446.

Similar to previous embodiments, the build bed 428 is again configured to support at least a portion of the material 12 and the object 11 while the object 11 is being formed. Additionally, the build bed 428 again includes a bed surface 428A upon which the material 12 is deposited and the object 11 is built, and a bed side wall 428B. However, in the embodiment illustrated in FIG. 4, the bed surface 428A is substantially flat, circular-shaped, and the bed side wall 428B is substantially circular tube-shaped and extends substantially vertically adjacent a perimeter of the bed surface 428A. In some embodiments, the bed side wall 428B is configured to prevent unwanted material 12 from falling outside the bed side wall 428B as the material 12 is deposited onto the bed surface 428A. In another implementation, the bed side wall 428B can be built concurrently as a custom shape around the object 11, while the object 11 is being built. Alternatively, the build bed 428 can have another suitable design and/or shape.

As above, the build area cover assembly 430 is again configured to selectively control an opening 432 onto the build bed 428 to define a variable material deposition area 434 within which the material 12 is actually deposited onto the build bed 428 and/or the build surface 429. Stated in another manner, the build area cover assembly 430 is again configured to selectively control a size and shape of the material deposition area 434 of the build surface 429. However, in this embodiment, the build area cover assembly 430 has a different design than in the previous embodiments. More particularly, in this embodiment, the build area cover assembly 430 includes a plurality of assembly members 430A that are configured to operate in a manner similar to an iris, e.g., a camera iris that is usable to selectively cover and uncover a portion of a camera lens. In such embodiment, each of the assembly members 430A can be selectively moved generally inwardly toward a center 428C (illustrated with a “+”) of the build bed 428 and/or generally outwardly away from the center 428C of the build bed 428 by one or more member movers 430B (e.g., one or more actuators, illustrated in phantom), as indicated generally by two-headed arrow 450. As such, each of the assembly members 430A are each configured to selectively cover and/or uncover a portion of the build bed 428 and/or the build surface 429. Additionally, in certain embodiments, each of the assembly members 430A can be substantially semicircular-shaped. Alternatively, each of the assembly members 430A can have another suitable shape. For example, in one non-exclusive alternative embodiment, the assembly members 430A can be positioned to overlap or be overlapped by each of the adjacent assembly members 430A. With such design, the assembly members 430A can be moved together in unison to define an approximately circular opening 432 and/or material deposition area 434 of a controllable diameter.

It is appreciated that the build area cover assembly 430 can include any suitable number of assembly members 430A. For example, in one embodiment, the build area cover assembly 430 can include nine assembly members 430A that each are selectively movable generally inwardly toward the center 428C of the build bed 428 and/or generally outwardly away from the center 428C of the build bed 428. Alternatively, the build area cover assembly 430 can include greater than nine or less than nine assembly members 430A.

Additionally, as with the previous embodiments, the assembly members 430A can be formed from any suitable materials. In certain implementations, the assembly members 430A can be formed from materials so as to inhibit any of the material 12 from sticking to the assembly members 430A during the build process. For example, in one implementation, the assembly members 430A can be formed from a high-temperature material, e.g., ceramic, tungsten, molybdenum, niobium, etc., so that the material 12 does not stick to such assembly members 430A as the material 12 is being melted during the build process.

It is further appreciated that the build area cover assembly 430 can include any suitable number of member movers 430B for purposes of moving the assembly members 430A generally inwardly toward the center 428C of the build bed 428 and/or generally outwardly away from the center 428C of the build bed 428. In one implementation, the build area cover assembly 430 can include a separate member mover 430B for moving each assembly member 430A. Alternatively, in another implementation, the build area cover assembly 430 can include member movers 430B that are capable of moving more than one of the assembly members 430A. Still alternatively, in still another implementation, the build area cover assembly 430 can include a single member mover 430B that is capable of moving each of the assembly members 430A, either individually or collectively. More particularly, in such implementation, the assembly members 430A can be collectively moved with a common member mover 430B, e.g., in a manner similar to a camera iris, to cooperatively define the material deposition area 434 that is approximately circular-shaped having a varying size.

It is appreciated that as the object 11 is being built, certain layers of the object 11 will require less material 12 than others to build the object 11 as desired. As such, the desired material layers 13 will not always be the same size. Thus, by depositing only that amount of material 12 onto the build bed 428 that is specifically desired for each material layer 13 (or just a little bit more), material 12 waste can be minimized. Stated in another manner, by selectively limiting the size of the opening 432 onto the build bed 428 for each material layer 13 with the build area cover assembly 430, and thus by selectively limiting the size of the variable material deposition area 434 accessible for each material layer 13, material 12 waste can be limited.

In certain implementations, the assembly members 430A of the build area cover assembly 430 can be moved and/or adjusted to selectively adjust the opening 432 and thus the variable material deposition area 434 for each material layer 13 as the object 11 is being built. Alternatively, in other implementations, the assembly members 430A of the build area cover assembly 430 can be moved and/or adjusted only once, prior to any building of the object 11, so that the opening 432 defines the variable material deposition area 434 that is the maximum size needed for any individual material layer 13 during the building of the object 11. With such alternative implementations, the assembly members 430A of the build area cover assembly 430 are only set once for each object 11 being built. Still alternatively, in still other implementations, the assembly members 430A of the build area cover assembly 430 can be adjusted prior to any building of the object 11 so that the opening 432 defines the variable material deposition area 434 that is the maximum size needed for any individual material layer 13 during the building of the object 11, but can then be moved and/or readjusted to the next (smaller) maximum size needed for any subsequent material layers 13 above the maximum size material layers 13. It is appreciated that in such implementations, the assembly members 430A of the build area cover assembly 430 can still be moved and/or adjusted multiple times, but only as many times as necessary to accommodate the size of the object 11 getting generally smaller toward a top of the object 11.

It is further appreciated that in some implementations, the depositing of the material 12 onto the build bed 428 can be controlled such that the material 12 is deposited so as to be slightly spaced apart from the assembly members 430A. As such, with a desired slight spacing between the material 12 and the assembly members 430A, the material 12 is inhibited from sticking to the assembly members 430A as the material 12 is being melted because there is no actual contact between the melted material 12 and the assembly members 430A.

As illustrated, the material receptacles 446 can be positioned substantially adjacent to the build bed 428. The material receptacles 446 are configured to receive and retain the excess material 12X that has been deposited onto the top of the assembly members 430A of the build area cover assembly 430. Additionally, in some implementations, the material receptacles 446 can be removable so that the excess material 12X can be quickly and easily removed and reused as desired.

The material mover 444 can be coupled to one or more of the material bed 26 (illustrated in FIG. 1A), the build bed 428, and the build area cover assembly 430. The material mover 444 is configured to distribute and/or level each successive material layer 13 that has been deposited onto the build bed 428. Additionally, the material mover 444 can be further configured to move any material 12 that has been deposited on top of the assembly members 430A of the build area cover assembly 430 by the material supply device 18 (illustrated in FIG. 1A) across the top of the assembly members 430A and into one of the material receptacles 446. Such excess material 12X that has been moved into the material receptacle 446 can then be removed and reused as desired.

It is understood that although a number of different embodiments of the processing machine 10 and/or the build area cover assembly 30 have been illustrated and described herein, one or more features of any one embodiment can be combined with one or more features of one or more of the other embodiments, provided that such combination satisfies the intent of the present disclosure.

While a number of exemplary aspects and embodiments of the processing machine 10 and/or the build area cover assembly 30 have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A processing machine for building a three-dimensional object from material, the processing machine comprising:
a build bed that is configured to support the material to provide a build surface at which the three-dimensional object is to be built;
a material supply device that is configured to deposit material to the build bed; and
a build area cover assembly that is configured to variably define a material deposition area of the build surface.

2. The processing machine of claim 1 further comprising a work member on which the three-dimensional object is built that is supported by the build bed; and wherein the material supply device deposits the material onto the work member.

3. The processing machine of claim 1 wherein the build area cover assembly is movable relative to the build bed and controls a size and shape of the material deposition area of the build surface.

4. The processing machine of claim 1 wherein the size and shape of the material deposition area is controlled by the build cover assembly covering at least a portion of the build surface.

5. The processing machine of claim 1 wherein the build area cover assembly is configured to control a size of an opening onto the build surface to control the size and shape of the material deposition area of the build surface.

6. The processing machine of claim 1 wherein the size of the material deposition area is variable based at least in part on the movement of the build area cover assembly.

7. The processing machine of claim 1 wherein the build area cover assembly also controls the amount of the material deposited within the material deposition area.

8. The processing machine of claim 1 further comprising a material bed that movably supports the build bed; and wherein the build area cover assembly is coupled to the material bed.

9. The processing machine of claim 1 wherein the build bed is movable relative to the material supply device.

10. The processing machine of claim 1 wherein the build area cover assembly includes one or more assembly members that are movable relative to the build bed with at least one member mover to cover the at least a portion of the build surface.

11. The processing machine of claim 10 wherein the one or more assembly members are formed from a high-temperature material.

12. The processing machine of claim 10 wherein the one or more assembly members includes a plurality of individually controllable thin plates that are each movable to cover at least a portion of the build surface.

13. The processing machine of claim 12 wherein the at least one member mover includes a separate member mover for each of the plurality of individually controllable thin plates.

14. The processing machine of claim 1 further comprising a material mover that is configured to level an upper material layer of the material that is deposited onto the build surface.

15. The processing machine of claim 14 wherein the material mover is further configured to move any excess material that has been deposited onto the build area cover assembly into a material receptacle that is positioned substantially adjacent to the build bed.

16. A method for building a three-dimensional object from material comprising:
providing a build bed that is configured to support the material to provide a build surface at which the three-dimensional object is to be built;
depositing material to the build bed with a material supply device; and
variably defining a material deposition area of the build surface with a build area cover assembly.

17. The method of claim 16 wherein the step of variably defining the material deposition area includes moving the build area cover assembly relative to the build bed to control a size and shape of the material deposition area of the build surface.

18. The method of claim 17 wherein moving includes adjusting the build area cover assembly prior to each material layer of material being deposited onto the build surface.

19. The method of claim 17 wherein moving includes adjusting the build area cover assembly only once prior to a first material layer of material being deposited onto the build surface such that the material deposition area is a maximum of any size needed during the building of the object.
